(19) United States
(12) Patent Application Publication
(10) Pub. No.: US 2009/0116574 A1
(43) Pub. Date: May 7, 2009

(54) METHODS AND APPARATUS FOR RECEIVE POWER UNIFICATION FOR MIMO AND NON-MIMO SIGNALING

(75) Inventor: Michael Mao Wang, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/265,310

(22) Filed: Nov. 5, 2008

Related U.S. Application Data
(60) Provisional application No. 60/985,965, filed on Nov. 6, 2007.

(51) Int. Cl. H04B 7/02

(52) U.S. Cl. 375/267

(57) ABSTRACT

A method for receive power unification for multiple-input and multiple-output (MIMO) and non-MIMO signaling is described. A data stream may be separated into multiple individual data streams for transmission by multiple transmit antennas. Orthogonal frequency division multiplexing (OFDM) may be applied to the individual data streams to obtain one or more OFDM symbols. Unification processing may be applied to an OFDM symbol. Individual data streams may be transmitted using multiple transmit antennas.

### CLAIM OF PRIORITY

The present application claims priority to U.S. Provisional Application No. 60/985,965, titled “Receive Power Unification for MIMO and Non-MIMO Signaling,” filed Nov. 6, 2007. The entirety of this provisional application is expressly incorporated herein by reference.

### TECHNICAL FIELD

The present disclosure relates generally to communication systems. More specifically, the present disclosure relates to methods and apparatus for receive power unification for MIMO and non-MIMO signaling.

### BACKGROUND

Wireless communication systems are widely deployed to provide various types of communication content such as voice, video, data, and so on. These systems may be multiple-access systems capable of supporting simultaneous communication of multiple terminals with one or more base stations.

As used herein, the term “mobile station” refers to an electronic device that may be used for voice and/or data communication over a wireless communication network. Examples of mobile stations include cellular phones, personal digital assistants (PDAs), handheld devices, wireless modems, laptop computers, personal computers, etc. A mobile station may alternatively be referred to as an access terminal, a mobile terminal, a subscriber station, a remote station, a user terminal, a terminal, a subscriber unit, user equipment, etc.

A wireless communication network may provide communication for a number of mobile stations, each of which may be serviced by a base station. A base station may alternatively be referred to as an access point, a Node B, or some other terminology.

A mobile station may communicate with one or more base stations via transmissions on the uplink and the downlink. The uplink (or reverse link) refers to the communication link from the mobile station to the base station, and the downlink (or forward link) refers to the communication link from the base station to the mobile station.

Communication between a terminal in a wireless system (e.g., a multiple-access system) and a base station is effected through transmissions over a wireless link comprised of a forward link and a reverse link. Such communication link may be established via a single-input and single-output (SISO), multiple-input and single-output (MISO), or a multiple-input and multiple-output (MIMO) system. A MIMO system consists of transmitter(s) and receiver(s) equipped, respectively, with multiple (M_{T}) transmit antennas and multiple (M_{R}) receive antennas for data transmission. SISO and MISO systems are particular instances of a MIMO system. The MIMO system can provide improved performance (e.g., higher throughput, greater capacity, or improved reliability) if the additional dimensionalities created by the multiple transmit and receive antennas are utilized.

Orthogonal frequency division multiple access (OFDMA) in combination with MIMO has been one of the most attractive air-interface solutions for wireless communication applications. In these applications, MIMO and non-MIMO signaling are often used together to fulfill different tasks. Due to the signal structural difference between the two signaling schemes, the receive power for MIMO signaling may be significantly different from the receive power for non-MIMO signaling even if the transmit power for MIMO and non-MIMO signals are the same. This may cause dynamic range increases at the receiver front end.

Benefits may be realized by improved systems and methods related to the operation of wireless communication networks implementing OFDMA in combination with MIMO signaling.

### BRIEF DESCRIPTION OF THE DRAWINGS

FIG. 1 shows a wireless communication system with multiple wireless devices;

FIG. 2 shows a block diagram of an OFDM-MIMO system including subsystems for the transmission and reception of data;

FIG. 3 illustrates a block diagram of an OFDM-MIMO transmitter that includes unification processing;

FIG. 4 illustrates a block diagram of an OFDM-MIMO transmitter that includes linear phase ramps;

FIG. 5 is a block diagram illustrating a MIMO wireless communication system with multiple wireless devices;

FIG. 6 is a flow diagram of a method for receive power unification for MIMO and non-MIMO signaling;

FIG. 6A illustrates means-plus-function blocks corresponding to the method of FIG. 6;

FIG. 7 is a flow diagram illustrating another method for receive power unification for MIMO and non-MIMO signaling;

FIG. 7A illustrates means-plus-function blocks corresponding to the method of FIG. 7; and

FIG. 8 illustrates certain components that may be included within a wireless device that is configured in accordance with the present disclosure.

### DETAILED DESCRIPTION

A method for receive power unification for multiple-input and multiple-output (MIMO) and non-MIMO signaling is described. A data stream is separated into multiple individual data streams for transmission by multiple transmit antennas. Orthogonal frequency division multiplexing (OFDM) is applied to the individual data streams to obtain one or more OFDM symbols. Unification processing is applied to an OFDM symbol. Individual data streams are transmitted using multiple transmit antennas.

Applying unification processing may include applying a phase ramp to an OFDM symbol. The slope of the phase ramp may be randomly selected. An inverse fast Fourier transform may be applied to each OFDM symbol to convert each OFDM symbol into the time domain. The data stream may include both MIMO and non-MIMO signaling. The unification processing may be applied to the non-MIMO portions of an OFDM symbol.

The non-MIMO portions of the OFDM symbol may include at least one of preamble and broadcast signals. The MIMO portions of the OFDM symbol may include user data traffic. Unification processing may reduce receive power variation according to at least one of channel and signal type. The slope of the phase ramp may be reselected from period to period to create time diversity as well as frequency selectivity, and to avoid static coverage holes of non-MIMO signals.

The phase ramp may be implemented by a cyclic shift in the time domain. The method for receive power unification for multiple-input and multiple-output (MIMO) and non-MIMO signaling may be implemented by a base station. The method for receive power unification for multiple-input and multiple-output (MIMO) and non-MIMO signaling may be implemented by a mobile station.

A wireless device configured for receive power unification for multiple-input and multiple-output (MIMO) and non-MIMO signaling is described. The wireless device may include a processor, memory in electronic communication with the processor, and instructions stored in the memory. The instructions are executable by the processor to separate a data stream into multiple individual data streams for transmission by multiple transmit antennas. The instructions are also executable to apply orthogonal frequency division multiplexing (OFDM) to the individual data streams to obtain one or more OFDM symbols. The instructions may be further executable to apply unification processing to an OFDM symbol. The instructions may also be executable to transmit the individual data streams using multiple transmit antennas.

A wireless device configured for receive power unification for multiple-input and multiple-output (MIMO) and non-MIMO signaling is also disclosed. The wireless device includes means for separating a data stream into multiple individual data streams for transmission by multiple transmit antennas. The wireless device also includes means for applying orthogonal frequency division multiplexing (OFDM) to the individual data streams to obtain one or more OFDM symbols. The wireless device may further include means for applying unification processing to an OFDM symbol. The wireless device may also include means for transmitting the individual data streams using multiple transmit antennas.

A computer-program product for a wireless device configured for receive power unification for multiple input multiple output (MIMO) and non-MIMO signaling is also disclosed. The computer-program product may include a computer-readable medium having instructions thereon, the instructions including code for separating a data stream into multiple individual data streams for transmission by multiple transmit antennas. The instructions may also include code for applying orthogonal frequency division multiplexing (OFDM) to the individual data streams to obtain one or more OFDM symbols. The instructions may further include code for applying unification processing to an OFDM symbol. The instructions may also include code for transmitting the individual data streams using multiple transmit antennas.

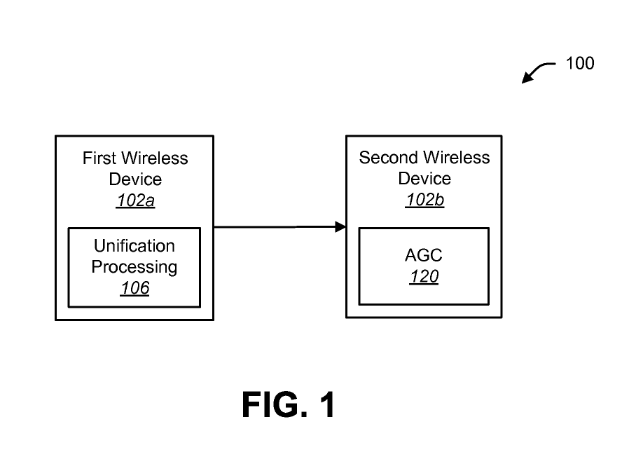

FIG. 1 shows a wireless communication system 100 with multiple wireless devices 102. A wireless device 102 may be a base station, a mobile station, a relay node, or the like. A base station is a station that communicates with one or more mobile stations. A base station may also be called, and may contain some or all of the functionality of, an access point, a Node B, an evolved Node B, etc. Each base station provides communication coverage for a particular geographic area. The term “cell” can refer to a base station and/or its coverage area depending on the context in which the term is used.

A mobile station may also be called, and may contain some or all of the functionality of, a terminal, an access terminal, a user equipment, a subscriber unit, a station, etc. A mobile station may be a cellular phone, a personal digital assistant (PDA), a wireless device, a wireless modem, a handheld device, a laptop computer, etc. A mobile station may communicate with zero, one, or multiple base stations on the downlink (DL) and/or uplink (UL) at any given moment. The downlink (or forward link) refers to the communication link from the base stations to the mobile stations, and the uplink (or reverse link) refers to the communication link from the mobile stations to the base stations.

A first wireless device 102a and second wireless device 102b may each utilize multiple receive and/or transmit antennas. The term “multiple-input and multiple-output” (MIMO) refers to the use of multiple antennas at both the transmitter and receiver to improve communication performance. At the transmitter, each portion of a data stream may be transmitted from a different antenna. At the receiver, the different portions of the data stream may be received by a different antenna and then combined. The terms “data stream” and “layer” are used interchangeably herein.

The first wireless device 102a may send a signal to the second wireless device 102b. The signal may be sent on the downlink (if the first wireless device 102a is a base station and the second wireless device 102b is a mobile station), the downlink (if the first wireless device 102a is a mobile station and the second wireless device 102b is a base station), or over an alternative link (for instance if the first wireless device 102a and the second wireless device 102b are both base stations or both mobile stations).

The first wireless device 102a may send a signal to the second wireless device 102b that includes both MIMO and non-MIMO signaling. MIMO and non-MIMO signaling are often used together to fulfill different tasks. For example, in MIMO applications, MIMO signaling may be used for sending unicast user traffic and non-MIMO signaling (e.g., single-input and single-output (SISO)) may be used for sending broadcast control signals and preambles. The first wireless device 102a may send a signal to the second wireless device 102b that uses orthogonal frequency division multiple access (OFDMA) in combination with MIMO to achieve high data rates.

Due to the structural signal difference between MIMO and non-MIMO signaling schemes, the receive power of the MIMO portions of the signal may be significantly different from the receive power of the non-MIMO portions of the signal. This may occur even if the transmit power for the MIMO portions and non-MIMO portions are the same. The receive power difference between MIMO signals and non-MIMO signals may impact the receiver automatic gain control (AGC) 120 and ultimately the receiver performance.

If it is assumed that the user traffic data are transmitted using MIMO signaling through M_{T} transmit antennas, the MIMO signal modulated onto the subcarrier of an OFDM symbol can be illustrated as:

xₖ=Φₖsₖ, k=1, 2, . . . ,N (1)

where s is a 1≦M≦M_{T} layer data symbol vector with E{ss^{H}}=I_{M×M}. The total energy of a layer data vector x is 1 (one) where the length of the layer data vector x is M (i.e., x contains M layer data). E is the expectation operation, S is the conjugate transpose of s, and I_{M×M} is the M×M identity matrix with ones along the diagonal and zeros everywhere else. Φ is a M_{T}×M unitary MIMO spatial multiplexing matrix. Φ can be fixed or random for random spatial multiplexing. The vector x contains M_{T} transmit symbols [x⁽¹⁾ x⁽²⁾ . . . x^{(M}^{_{T}}⁾]^{-T}, and N is the number of subcarriers of an OFDM symbol. The received sample of the k^{th} subcarrier can be written as:

$${y}_{k} = \sqrt{\frac{1}{N}} {H}_{k} {x}_{k} + {n}_{k} \qquad ( 2 )$$

where y is the M_{R}×1 received signal vector with M_{R} receiving antennas, H is the M_{R}×M_{T} channel matrix and n is the M_{R}×1 noise vector. The noise vector may be omitted for the simplicity of analysis. A received sample of the k^{th} subcarrier from one receive antenna may be expressed as:

$${y}_{k} = \sqrt{\frac{1}{N}} {\sum }_{a = 1}^{{M}_{T}} {h}_{k}^{( a )} {x}_{k}^{( a )} , k = 1 , 2 , … , N , a = 1 , 2 , … , {M}_{T} \qquad ( 3 )$$

where h^{(a)} is the a^{th} antenna channel gain with E{|h^{(a)}|²}=1, and

$${x}^{( a )} = {\sum }_{r = 1}^{M} {φ}^{( a , r )} {s}^{( r )} .$$

In this equation, r is a summation dummy variable used to denote the r^{th} rank, i.e. summation over all ranks.

The total receive OFDM symbol power on one antenna is:

$$\begin{matrix}E \{ {\sum }_{k = 1}^{N} {\vert {y}_{k} \vert}^{2} \} = \frac{1}{N} E \{ {\sum }_{k = 1}^{N} ( ( {\sum }_{a = 1}^{{M}_{t}} {h}_{k}^{( a )} {x}_{k}^{( a )} ) {( {\sum }_{b = 1}^{{M}_{t}} {h}_{k}^{( b )} {x}_{k}^{( b )} )}^{*} ) \} \\ = 1 + \frac{1}{N} {\sum }_{k = 1}^{N} {\sum }_{a = 1}^{{M}_{t}} {\sum }_{b \neq a} E \{ {{h}_{k}^{( a )} ( {h}_{k}^{( b )} )}^{*} \} E \{ {{x}_{k}^{( a )} ( {x}_{k}^{( b )} )}^{*} \}\end{matrix} \qquad ( 4 )$$

where b is a summation variable used to denote summation over all antennas.

$$\begin{matrix}E \{ {{x}_{k}^{( a )} ( {x}_{k}^{( b )} )}^{*} \} = E \{ ( {\sum }_{r = 1}^{M} {φ}^{( a , r )} {s}^{( r )} ) {( {\sum }_{r = 1}^{M} {φ}^{( b , r )} {s}^{( r )} )}^{*} \} \\ = {\sum }_{r = 1}^{M} {\sum }_{t = 1}^{M} E \{ {φ}^{( a , r )} {φ}^{( b , t )} {s}^{( r )} {s}^{( t )} \} \\ = {\sum }_{r = 1}^{M} {\sum }_{t = 1}^{M} E \{ {φ}^{( a , r )} {φ}^{( b , t )} \} E \{ {s}^{( r )} {s}^{( t )} \} .\end{matrix} \qquad ( 5 )$$

Note that E{s^{(r)}s^{(t)}}={s^{(r)}}E{s^{(t)}}=0 for r≠t. Therefore,

E{xₖ^{(a)}(xₖ^{(b)})*}=0 (6)

and hence

$$E \{ {\sum }_{k = 1}^{N} {\vert {y}_{k} \vert}^{2} \} = 1 + \frac{1}{N} {\sum }_{k = 1}^{N} {\sum }_{a = 1}^{{M}_{t}} {\sum }_{b \neq a} E \{ {{h}_{k}^{( a )} ( {h}_{k}^{( b )} )}^{*} \} \cdot 0 = 1 \qquad ( 7 )$$

regardless of the value of E{hᵥ^{(a)}(hₖ^{(b)}*)}. That is, the received power for MIMO signals is channel independent.

A non-MIMO signal modulated onto the k^{th} OFDM subcarrier on the a^{th} antenna can be represented as:

$${x}_{k}^{( a )} = \sqrt{\frac{1}{{M}_{T}}} {s}_{k} , k = 1 , … , N , a = 1 , … , {M}_{T} \qquad ( 8 )$$

Thus, the same non-MIMO signal is transmitted on each of the M_{T} antennas that also transmit the MIMO signals. The total power of the non-MIMO signals may be evenly distributed over all the antennas. It may be impractical to radiate the total non-MIMO signal power through one of the M_{T} transmit antennas due to the power limit of the amplifier of each antenna. It is therefore undesirable to transmit a non-MIMO signal on a single antenna. Thus, the transmit power difference between MIMO and non-MIMO signals is 1/M_{T} for each transmitting antenna.

The corresponding received total power of the OFDM symbol is

$$\begin{matrix}E \{ {\sum }_{k = 1}^{N} {\vert {y}_{k} \vert}^{2} \} = \frac{1}{{NM}_{T}} E \{ {\sum }_{k = 1}^{N} ( ( {\sum }_{a = 1}^{{M}_{T}} {h}_{k}^{( a )} {s}_{k} ) {( {\sum }_{b = 1}^{{M}_{T}} {h}_{k}^{( b )} {s}_{k} )}^{*} ) \} \\ = 1 + \frac{1}{{NM}_{T}} {\sum }_{k = 1}^{N} {\sum }_{a = 1}^{{M}_{T}} {\sum }_{b \neq a} E \{ {{h}_{k}^{( a )} ( {h}_{k}^{( b )} )}^{*} \}\end{matrix} \qquad ( 9 )$$

Thus, in non-MIMO signal transmissions, the receive power is channel dependent. In other words, the receive power is a function of channel correlations. It is known from the Cauchy-Schwarz inequality that

−1≦E{hₖ^{(a)}(hₖ^{(b)})*}≦1 (10)

The maximum receive power happens when the channels are positively correlated. This may also be referred to as up fades. For example, the maximum receive power may occur when E{hₖ^{(a)}(hₖ^{(b)})*}−1:

$${max}_{\{ {h}^{( a )} , {h}^{( b )} \}} \{ E \{ {\sum }_{k = 1}^{N} {\vert {y}_{k} \vert}^{2} \} \} = 1 + \frac{1}{{NM}_{T}} {max}_{\{ {h}^{( a )} , {h}^{( b )} \}} \{ {\sum }_{k = 1}^{N} {\sum }_{a = 1}^{{M}_{T}} {\sum }_{b \neq a} E \{ {{h}_{k}^{( a )} ( {h}_{k}^{( b )} )}^{*} \} \} = 1 + ( {M}_{T} - 1 ) = {M}_{T} \qquad ( 11 )$$

A simple example of when the maximum receive power occurs is a line of sight (LOS) channel with h^{(a)}=1, 1≦a≦M_{T}.

The minimum receive power is reached when the channels are anti-correlated. This may also be referred to as down fades. For example, the minimum receive power may occur when E{hₖ^{(a)}(hₖ^{(b)})*}=−1:

$${min}_{\{ {h}^{( a )} , {h}^{( b )} \}} \{ E \{ {\sum }_{k = 1}^{N} {\vert {y}_{k} \vert}^{2} \} \} = 1 + \frac{1}{{NM}_{T}} {min}_{\{ {h}^{( a )} , {h}^{( b )} \}} \{ {\sum }_{k = 1}^{N} {\sum }_{a = 1}^{{M}_{T}} {\sum }_{b \neq a} E \{ {{h}_{k}^{( a )} ( {h}_{k}^{( b )} )}^{*} \} \} = 1 + ( - 1 ) = 0 \qquad ( 12 )$$

Thus, unlike the MIMO signal, the receive power of non-MIMO signals depends on the channel. The receive power of a non-MIMO signal may be as much as M_{T} times higher than that of a MIMO signal. For M_{T}=2, the receive power of a non-MIMO signal may be 3 dB higher than the receive power for a MIMO signal. For M_{T}=4, the receive power of a non-MIMO signal may be 6 dB higher than the receive power for a MIMO signal. For M_{T}=8, the receive power of a non-MIMO signal may be 9 dB higher than the receive power for a MIMO signal. This disparity may impair the operation of the receiver. For example, the automatic gain control (AGC) 120 operation on the receiver may require larger receiver dynamic ranges than the receiver is capable of. The first wireless device 102a may use unification processing 106 on the transmitted signal.

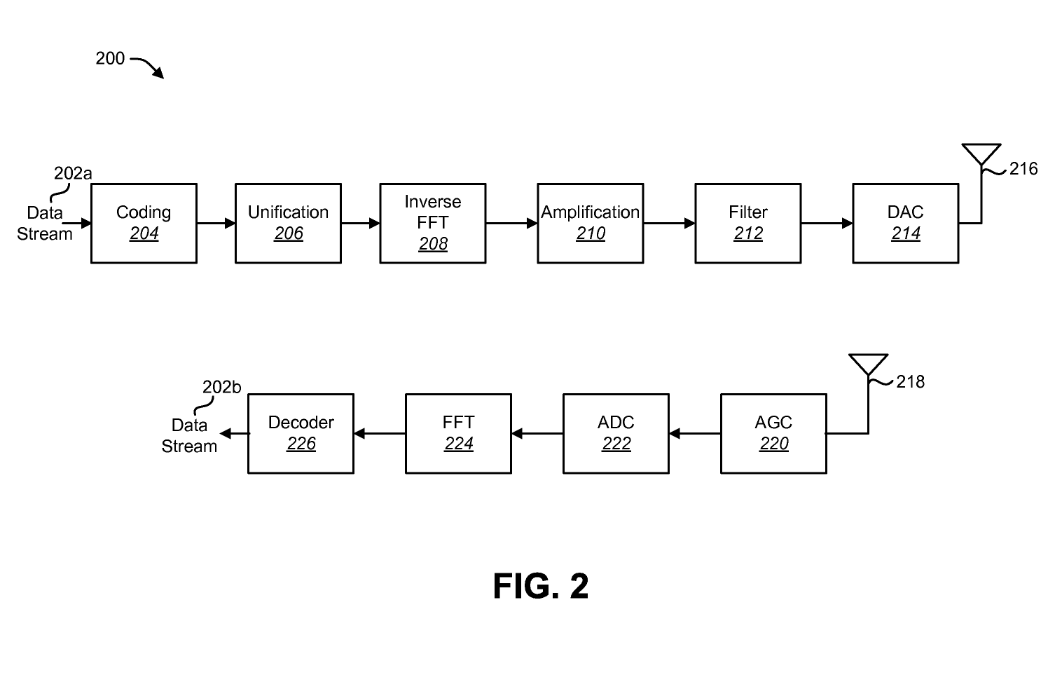

FIG. 2 shows a block diagram of an OFDM-MIMO system 200 including subsystems for the transmission and reception of data. A data stream 202a for transmission may be encoded from a data source. The data stream 202a may be in the frequency domain. In a typical OFDM forward link transmission, MIMO and non-MIMO signals are time and/or frequency multiplexed in the transmission stream and are typically transmitted on the same transmit antennas. The data stream 202a may include both MIMO and non-MIMO portions. For example, the preamble and other broadcast signals may be non-MIMO and the user data traffic may be MIMO with variable spatial multiplexing layers or ranks.

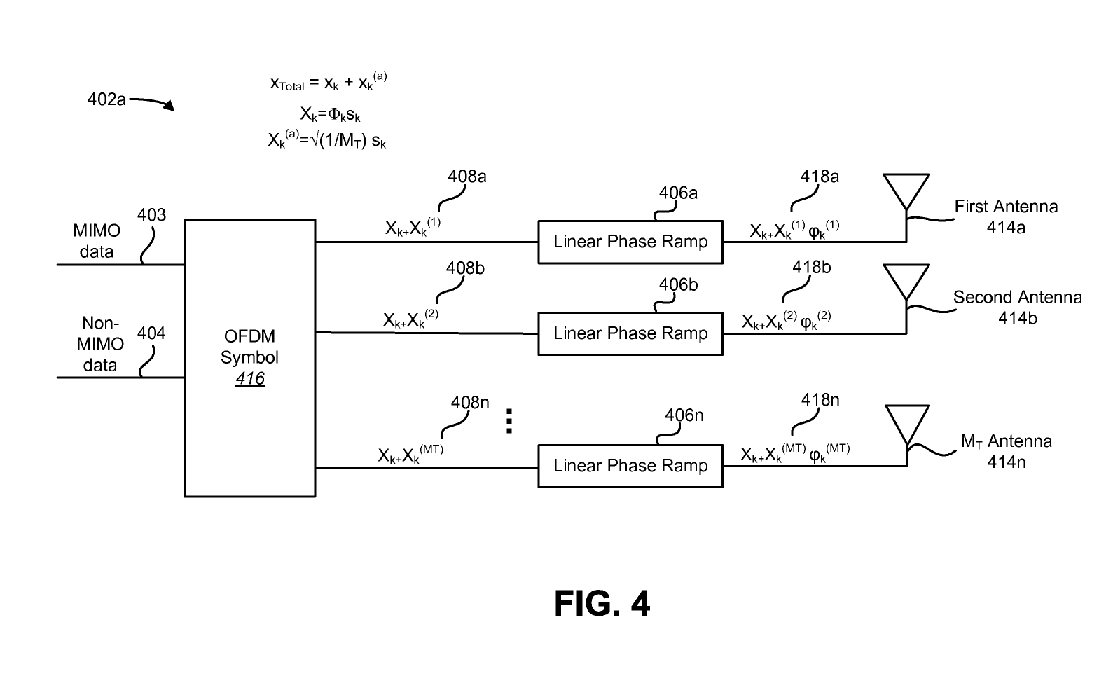

A unification processing subsystem 206 may apply a phase ramp to the data stream 202a. Phase ramps are discussed in further detail below in relation to FIG. 4. An inverse fast Fourier transform (IFFT) unit 208 may convert the data stream 202a from the frequency domain into the time domain. The data stream 202a may then receive amplification 210 and filtering 212. The data stream 202a may be converted from a digital signal to an analog signal using a digital-to-analog converter (DAC) 214. The data stream 202a may then be transmitted by one or more antennas 216 of a wireless device 102a as part of the OFDM-MIMO system 200. The transmitting wireless device 102a may be referred to as a transmitter.

The data stream 202a may be received by one or more antennas 218 of a wireless device 102b as part of the OFDM-MIMO system 200. The receiving wireless device 102b may be referred to as a receiver. The receiver 102b may include an automatic gain control (AGC) 220 subsystem. The AGC 220 subsystem may adjust the gain applied to received signals to maintain an approximately constant average output power. The receiver 102b may convert the received signal into a digital signal using an analog-to-digital converter (ADC) 222. The receiver 102b may then apply a fast Fourier transform (FFT) 224 to the received signal. The FFT 224 may convert the received signal from the time domain to the frequency domain. A decoder 226 may decode the received signal to obtain the original data stream 202b.

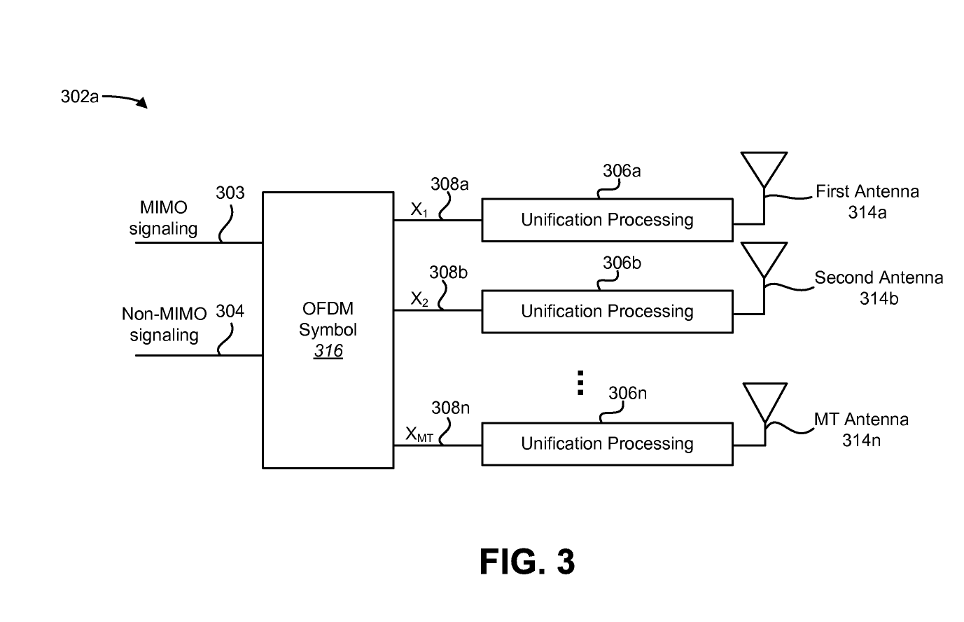

FIG. 3 illustrates a block diagram of an OFDM-MIMO transmitter 302a that includes unification processing. The transmitter 302a may receive a data stream having MIMO signaling 303 and non-MIMO signaling 304. The transmitter 302a may encode the data stream to an OFDM symbol 316 one symbol at a time in the frequency domain. The transmitter 302a may further separate the OFDM symbol 316 into multiple streams 308a-n, one for each transmitting antenna 314a-n. Each of the separated streams 308a-n may include independent data within the same frequency band. The transmitter 302a may apply unification processing 306a-n to each of the separated streams 308a-n. Unification processing 306a-n may include applying a linear phase ramp to each of the separated streams 308a-n. Each of the separated streams 308a-n may then be sent on the corresponding transmit antennas 314a-n simultaneously in the same frequency band.

FIG. 4 illustrates a block diagram of an OFDM-MIMO transmitter 402a that includes linear phase ramps 406. The transmitter 402a may include a data stream having MIMO signaling 403 and non-MIMO signaling 404. The transmitter 402a may encode the data stream to an OFDM symbol 416. The transmitter 402a may further separate the OFDM symbol 416 into separate streams 408a-n for each transmitting antenna 414a-n. For each transmitting antenna 414a-n, the corresponding data stream may be referred to as x_{Total}=xₖ+xₖ^{(a)} where xₖ represents the MIMO signal 403 and xₖ^{(a)} represents the non-MIMO signal 404. From equation (1) above, xₖ=Φₖsₖ, k=1, 2, . . . ,N. From equation (8) above,

$${x}_{k}^{( a )} = \sqrt{\frac{1}{{M}_{T}}} {s}_{k} , k = 1 , … , N , a = 1 , … , {M}_{T} .$$

To reduce the channel dependency for the receive power of non-MIMO signals 404, the non-MIMO symbol on each subcarrier of an OFDM symbol 416 on each transmit antenna 414 may be multiplied by a factor φₖ^{(a)} to obtain

xₖ^{(a)}φₖ^{(a)}=sₖφₖ^{(a)}, k=1, . . . ,N, a=1, . . . ,M_{T} (13)

The maximum/minimum received OFDM symbol power from equation (9) becomes

$$\begin{matrix}E \{ {\sum }_{k = 1}^{N} {\vert {y}_{k} \vert}^{2} \} = 1 + \frac{1}{N} {\sum }_{k = 1}^{N} {\sum }_{a = 1}^{{M}_{T}} {\sum }_{b \neq a} E \{ {{h}_{k}^{( a )} ( {h}_{k}^{( b )} )}^{*} \} {{ϕ}_{k}^{( a )} ( {ϕ}_{k}^{( b )} )}^{*} \\ = 1 \pm \frac{1}{N} {\sum }_{a = 1}^{{M}_{T}} {\sum }_{b \neq a} ( {\sum }_{k = 1}^{N} {{ϕ}_{k}^{( a )} ( {ϕ}_{k}^{( b )} )}^{*} )\end{matrix} \qquad ( 14 )$$

It is desired that

$${\sum }_{k = 1}^{N} {{ϕ}_{k}^{( a )} ( {ϕ}_{k}^{( b )} )}^{*} = 0.$$

This can be achieved by letting

$${ϕ}_{k}^{( a )} = {e}^{j ( \frac{2 π}{N} {m}^{( a )} ) k} \qquad ( 15 )$$

where

m^{(a)}∈{0,±1,±2, . . . ,Q}, a=1,2, . . . ,M_{T} (16)

Equation (15) with the limitations of equation (16), where Q is an integer, gives a linear phase ramp 406. The linear phase ramp 406 is such that:

$${\sum }_{k = 1}^{N} {{ϕ}_{k}^{( a )} ( {ϕ}_{k}^{( b )} )}^{*} = {\sum }_{k = 1}^{N} {e}^{j \frac{2 π}{N} ( {m}^{( a )} - {m}^{( b )} ) k} = 0 \qquad ( 17 )$$

as long as

m^{(a)}−m^{(b)}≠0, a,b=1,2, . . . ,M_{T} (18)

which results in a unified receive power

$$E \{ {\sum }_{k = 1}^{N} {\vert {y}_{k} \vert}^{2} \} = 1 \qquad ( 19 )$$

When the linear phase ramp 406 is applied to the non-MIMO portions of a data stream before transmission, the channel correlation effect on the receive power of the non-MIMO signals 404 may be minimized or eliminated.

Each transmitting antenna 414 may select the value of m for equation (16) in a random fashion. This may randomize the transmit signals 418 and create time diversity. The value m may represent the slope of the phase ramp 406. Reselecting the value of m may also create frequency selectivity to avoid static coverage holes of non-MIMO signals 404.

The use of a phase ramp 406 for slow phase ramping does not affect the broadband channel estimation usually being performed for non-MIMO signals 404 at the receiver 102b. The effect on the receiver channel estimation may be the same as that of channel variation.

The phase ramping operation may affect the receiver 102b performance. The phase ramping operation may be efficiently implemented by a cyclic shift in the time domain. After the phase ramping operation, the received signal power variation is reduced regardless of the channels or the signal types used.

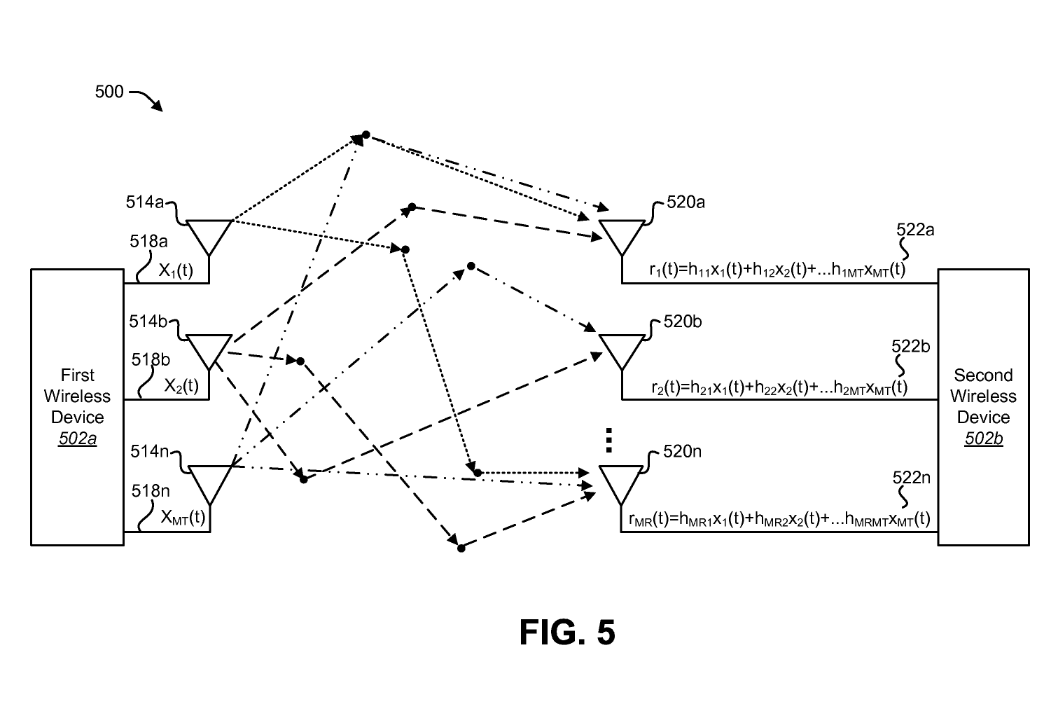

FIG. 5 is a block diagram illustrating a MIMO wireless communication system 500 with multiple wireless devices 502a, 502b. A first wireless device 502a may include a data stream to be transmitted to a second wireless device 502b. The first wireless device 502a may separate the data stream into multiple transmission signals 518a-n for transmission by M_{T} antennas 514a-n. For example, a data stream x may be separated into x₁(t), x₂(t), . . . ,x_{M}_{_{T}}(t) where x₁(t)+x₂(t)+ . . . +x_{M}_{_{T}}(t)=x. The first wireless device 502a may then transmit each of the separate signals 518a-n in parallel using the multiple transmit antennas 514a-n.

The second wireless device 502b may receive the transmission signals 518a-n using M_{R} receive antennas 520a-n, where M_{R}≧M_{T}. The transmission signals 518a-n may combine between transmission by the first wireless device 502a and reception by the second wireless device 502b. Because each transmission signal 518a-n may travel from a transmit antenna 514a-n to a receive antenna 520a-n over a different path, each of the independent channel streams is received with an estimated individual channel weight h. Thus, the received signal 522a by the first antenna 520a may be represented by r₁(t)=h₁₁x₁(t)+h₁₂x₂(t)+ . . . h_{1M}_{_{T}}x_{M}_{_{T}}(t), the received signal 522b by the second antenna 520b may be represented by r₂(t)=h₂₁x₁(t)+h₂₂x₂(t)+ . . . h_{2M}_{_{T}}x_{M}_{_{T}}(t) and the received signal 522n by antenna M_{R} 520n may be represented by r_{M}_{_{R}}(t)=h_{M}_{_{R}}₁x₁(t)+h_{M}_{_{R}}₂x₂(t)+ . . . h_{M}_{_{R}}_{M}_{_{T}}x_{M}_{_{T}}(t). To recover x, the second wireless device 502b may construct a channel matrix H using the estimated individual channel weights h. The second wireless device 502b may solve for the transmitted vector x by multiplying the received vector r with the inverse of H. The second wireless device 502b may thus recover the original data stream that was transmitted.

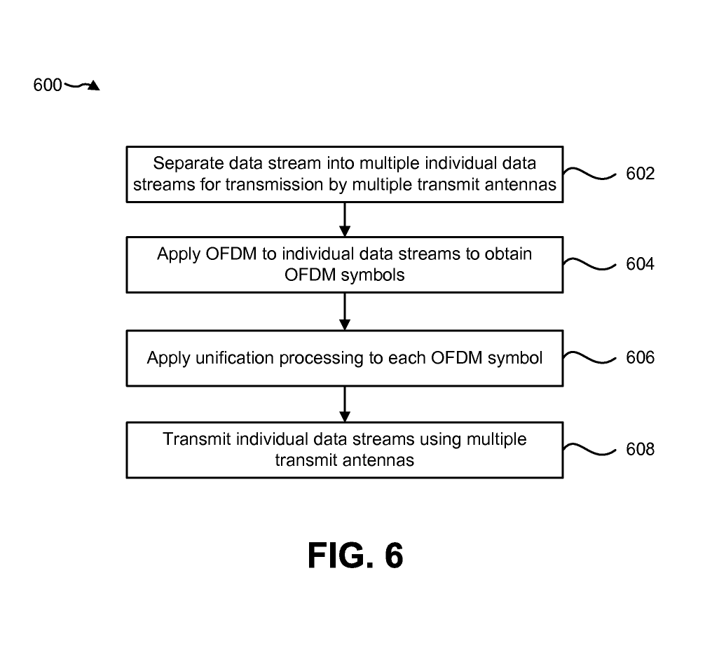

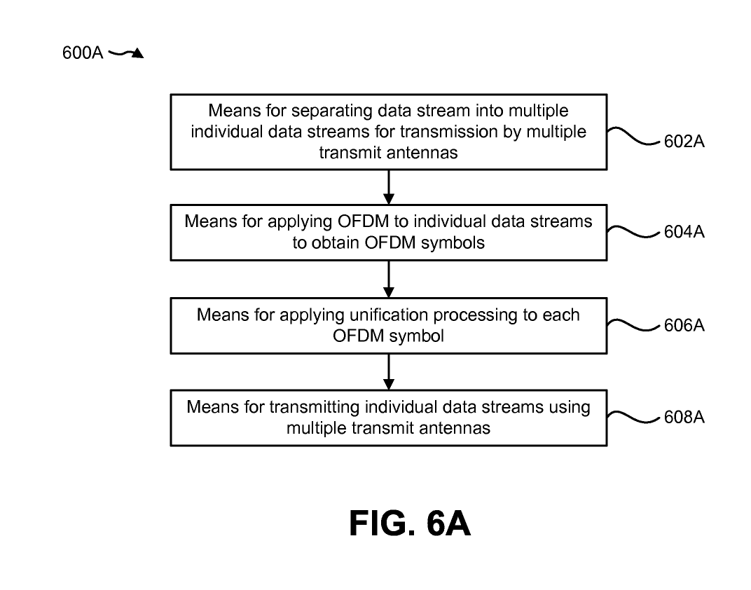

FIG. 6 is a flow diagram of a method 600 for receive power unification for MIMO and non-MIMO signaling. A wireless device 402a may separate 602 a data stream into multiple individual data streams for transmission by multiple transmit antennas 414. The data stream may include MIMO data 403 and non-MIMO data 404. For example, the preamble and broadcast portions of the data stream may be non-MIMO data 404 and the user traffic portions of the data stream may be MIMO data 403.

The wireless device 402a may separate 602 the data stream into multiple data streams such that there is spatial diversity between the multiple data streams to increase the data capacity. Alternatively, the wireless device 402a may separate 602 the data stream into multiple data streams such that there is temporal diversity between the multiple data streams to reduce signal fading.

The wireless device 402a may then apply 604 orthogonal frequency division multiplexing (OFDM) to each of the individual data streams to obtain OFDM symbols 416. The individual data streams may be modulated using orthogonal subcarriers such that each element of the domain signal vector is used to modulate a respective subcarrier frequency of the carrier signal and obtain OFDM symbols 416.

The wireless device 402a may apply 606 unification processing 306 to the OFDM symbols 416. The unification processing 306 may be applied to only the non-MIMO portions 404 of the OFDM symbols 416. For example, the non-MIMO symbol 404 on each subcarrier of an OFDM symbol 416 on each transmit antenna 414 may be multiplied by a unification factor. Alternatively, the unification processing 306 may be applied to both the non-MIMO portion 404 and the MIMO portion 403 of the OFDM symbols 416. The unification processing 306 may include applying a phase ramp 406 to each OFDM symbol 416 in the OFDM symbol frequency domain. The unification processing 306 may minimize the channel correlation effect on the receive power for the individual data streams.

The wireless device 402a may transmit 608 the individual data streams using multiple transmit antennas 414. Each transmit antenna 414 may transmit 608 one of the individual data streams 418 in parallel with the other transmit antennas 414.

The method 600 of FIG. 6 described above may be performed by various hardware and/or software component(s) and/or module(s) corresponding to the means-plus-function blocks 600A illustrated in FIG. 6A. In other words, blocks 602 through 608 illustrated in FIG. 6 correspond to means-plus-function blocks 602A through 608A illustrated in FIG. 6A.

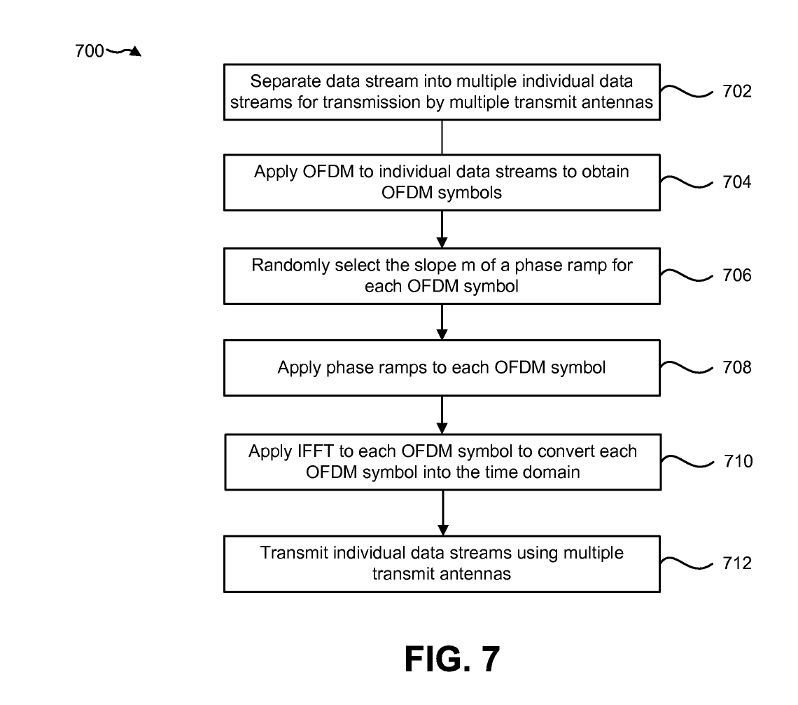

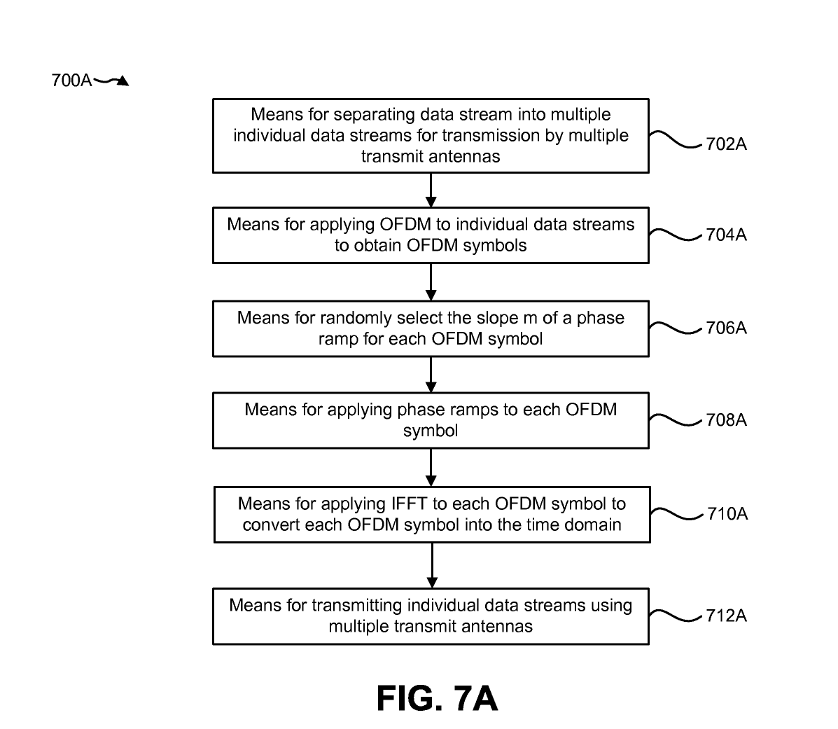

FIG. 7 is a flow diagram illustrating another method 700 for receive power unification for MIMO and non-MIMO signaling. A wireless device 402a may separate 702 a data stream into multiple individual data streams for transmission by multiple transmit antennas 414. The wireless device 402a may apply 704 OFDM to the individual data streams to obtain OFDM symbols 416.

The wireless device 402a may then randomly select 706 the slope of a phase ramp 406 for each OFDM symbol 416. In one example, the phase ramp 406 may multiply the non-MIMO symbol 404 on each subcarrier of an OFDM symbol 416 on each transmit antenna 414 by a factor φₖ^{(a)}. As discussed above in relation to equation (15), one possible phase ramp 406 may be represented by

$${ϕ}_{k}^{( a )} = {e}^{j ( \frac{2 π}{N} {m}^{( a )} ) k} .$$

The slope of the linear phase ramp 406 of equation (15) may be equal to m. Thus, the wireless device 402a may randomly select 706 the value of m within the constraints of equation (16) and apply 708 the phase ramp 406 of equation (15) to each OFDM symbol 416 using the formula of equation (13): xₖ^{(a)}φₖ^{(a)}=sₖφₖ^{(a)}, k=1, . . . ,N, a=1, . . . ,M_{T}.

The wireless device 402a may apply 710 an IFFT to each OFDM symbol 416 to convert each OFDM symbol 416 into the time domain. The wireless device 402a may then transmit 712 the individual data streams 418 in the time domain using multiple transmit antennas 414.

The method 700 of FIG. 7 described above may be performed by various hardware and/or software component(s) and/or module(s) corresponding to the means-plus-function blocks 700A illustrated in FIG. 7A. In other words, blocks 702 through 712 illustrated in FIG. 7 correspond to means-plus-function blocks 702A through 712A illustrated in FIG. 7A.

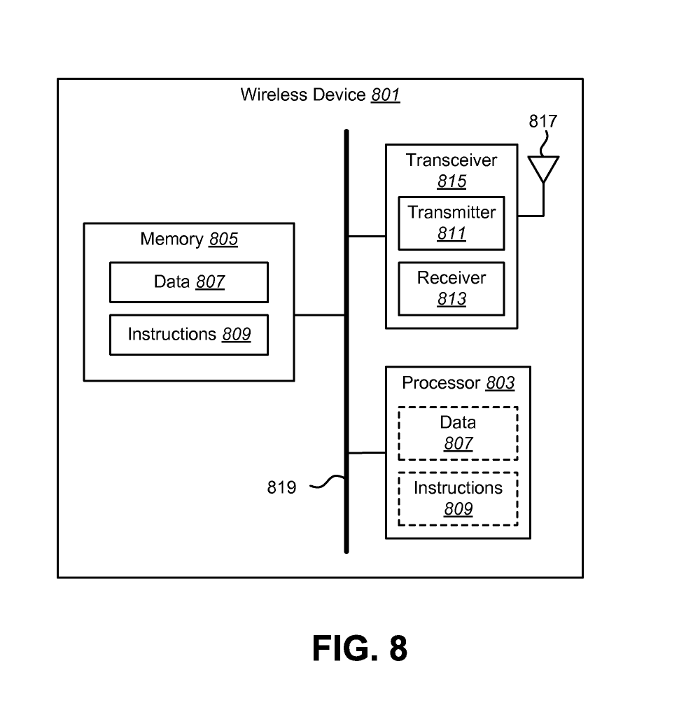

FIG. 8 illustrates certain components that may be included within a wireless device 801. The wireless device 801 may be a mobile station or a base station.

The wireless device 801 includes a processor 803. The processor 803 may be a general purpose single- or multi-chip microprocessor (e.g., an ARM), a special purpose microprocessor (e.g., a digital signal processor (DSP)), a microcontroller, a programmable gate array, etc. The processor 803 may be referred to as a central processing unit (CPU). Although just a single processor 803 is shown in the wireless device 801 of FIG. 8, in an alternative configuration, a combination of processors (e.g., an ARM and DSP) could be used.

The wireless device 801 also includes memory 805. The memory 805 may be any electronic component capable of storing electronic information. The memory 805 may be embodied as random access memory (RAM), read only memory (ROM), magnetic disk storage media, optical storage media, flash memory devices in RAM, on-board memory included with the processor, EPROM memory, EEPROM memory, registers, and so forth, including combinations thereof.

Data 807 and instructions 809 may be stored in the memory 805. The instructions 809 may be executable by the processor 803 to implement the methods disclosed herein. Executing the instructions 809 may involve the use of the data 807 that is stored in the memory 805.

The wireless device 801 may also include a transmitter 811 and a receiver 813 to allow transmission and reception of signals between the wireless device 801 and a remote location. The transmitter 811 and receiver 813 may be collectively referred to as a transceiver 815. An antenna 817 may be electrically coupled to the transceiver 815. The wireless device 801 may also include (not shown) multiple transmitters, multiple receivers, multiple transceivers and/or multiple antenna.

The various components of the wireless device 801 may be coupled together by one or more buses, which may include a power bus, a control signal bus, a status signal bus, a data bus, etc. For the sake of clarity, the various buses are illustrated in FIG. 8 as a bus system 819.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in hardware, software, firmware, or any combination thereof. If implemented in software, the functions may be stored as one or more instructions on a computer-readable medium. The term “computer-readable medium” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 6 and 7, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for receive power unification for multiple-input and multiple-output (MIMO) and non-MIMO signaling, the method comprising:
separating a data stream into multiple individual data streams for transmission by multiple transmit antennas;
applying orthogonal frequency division multiplexing (OFDM) to the individual data streams to obtain one or more OFDM symbols;
applying unification processing to an OFDM symbol; and
transmitting the individual data streams using multiple transmit antennas.

2. The method of claim 1, wherein applying unification processing comprises applying a phase ramp to an OFDM symbol.

3. The method of claim 2, further comprising randomly selecting the slope of the phase ramp.

4. The method of claim 1, further comprising applying an inverse fast Fourier transform to each OFDM symbol to convert each OFDM symbol into the time domain.

5. The method of claim 1, wherein the data stream includes both MIMO and non-MIMO signaling.

6. The method of claim 5, wherein the unification processing is applied to the non-MIMO portions of an OFDM symbol.

7. The method of claim 6, wherein the non-MIMO portions of the OFDM symbol comprise at least one of preamble and broadcast signals, and wherein the MIMO portions of the OFDM symbol comprise user data traffic.

8. The method of claim 1, wherein unification processing reduces receive power variation according to at least one of channel and signal type.

9. The method of claim 1, further comprising reselecting the slope of the phase ramp from period to period to create time diversity as well as frequency selectivity, and to avoid static coverage holes of non-MIMO signals.

10. The method of claim 2, wherein the phase ramp is implemented by a cyclic shift in the time domain.

11. The method of claim 1, wherein the method is implemented by a base station.

12. The method of claim 1, wherein the method is implemented by a mobile station.

13. A wireless device configured for receive power unification for multiple-input and multiple-output (MIMO) and non-MIMO signaling, comprising:
a processor;
memory in electronic communication with the processor;
instructions stored in the memory, the instructions being executable by the processor to:
separate a data stream into multiple individual data streams for transmission by multiple transmit antennas;
apply orthogonal frequency division multiplexing (OFDM) to the individual data streams to obtain one or more OFDM symbols;
apply unification processing to an OFDM symbol; and
transmit the individual data streams using multiple transmit antennas.

14. The wireless device of claim 13, wherein applying unification processing comprises applying a phase ramp to an OFDM symbol.

15. The wireless device of claim 14, wherein the instructions are further executable to randomly select the slope of the phase ramp.

16. The wireless device of claim 13, wherein the instructions are further executable to apply an inverse fast Fourier transform to each OFDM symbol to convert each OFDM symbol into the time domain.

17. The wireless device of claim 13, wherein the data stream includes both MIMO and non-MIMO signaling.

18. The wireless device of claim 17, wherein the unification processing is applied to the non-MIMO portions of an OFDM symbol.

19. The wireless device of claim 18, wherein the non-MIMO portions of the OFDM symbol comprise at least one of preamble and broadcast signals, and wherein the MIMO portions of the OFDM symbol comprise user data traffic.

20. The wireless device of claim 13, wherein unification processing reduces receive power variation according to at least one of channel and signal type.

21. The wireless device of claim 13, wherein the instructions are further executable to reselect the slope of the phase ramp from period to period to create time diversity as well as frequency selectivity, and to avoid static coverage holes of non-MIMO signals.

22. The wireless device of claim 14, wherein the phase ramp is implemented by a cyclic shift in the time domain.

23. The wireless device of claim 13, wherein the wireless device is a base station.

24. The wireless device of claim 13, wherein the wireless device is a mobile station.

25. A wireless device configured for receive power unification for multiple-input and multiple-output (MIMO) and non-MIMO signaling, comprising:
means for separating a data stream into multiple individual data streams for transmission by multiple transmit antennas;
means for applying orthogonal frequency division multiplexing (OFDM) to the individual data streams to obtain one or more OFDM symbols;
means for applying unification processing to an OFDM symbol; and
means for transmitting the individual data streams using multiple transmit antennas.

26. A computer-program product for a wireless device configured for receive power unification for multiple input multiple output (MIMO) and non-MIMO signaling, the computer-program product comprising a computer-readable medium having instructions thereon, the instructions comprising:
code for separating a data stream into multiple individual data streams for transmission by multiple transmit antennas;
code for applying orthogonal frequency division multiplexing (OFDM) to the individual data streams to obtain one or more OFDM symbols;
code for applying unification processing to an OFDM symbol; and
code for transmitting the individual data streams using multiple transmit antennas.
